(19) United States
(12) Patent Application Publication
(10) Pub. No.: US 2026/0329150 A1
(43) Pub. Date: Oct. 22, 2026

(54) CONTROL APPARATUS, ILLUMINATION SYSTEM, CONTROL METHOD, AND STORAGE MEDIUM

(71) Applicant: CANON KABUSHIKI KAISHA, Tokyo (JP)

(72) Inventor: SOUHEI MIYAMOTO, Kanagawa (JP)

(21) Appl. No.: 19/575,009

(22) Filed: Mar. 23, 2026

(30) Foreign Application Priority Data
Apr. 16, 2025 (JP) 2025-067702

(51) Int. Cl. G03B 15/05; G05D 25/02

(52) U.S. Cl. CPC G03B 15/05; G05D 25/02

(57) ABSTRACT

A control apparatus controls a plurality of illumination apparatuses each having a first light emitter and a second light emitter. The control apparatus communicates with each of the plurality of illumination apparatuses, sets a light amount of the first light emitter of each of the plurality of illumination apparatuses, and acquires a first light amount ratio of reflected light from an object obtained by causing first light emitters of the plurality of illumination apparatuses to emit light with the light amounts.

### BACKGROUND

### Field of the Technology

The present disclosure relates to a control apparatus, an illumination system, a control method, and a storage medium.

### Description of the Related Art

Japanese Patent Application Laid-Open No. 2011-059406 discloses a method of capturing an image using an image pickup apparatus and a plurality of strobe light emitting apparatuses.

However, the method disclosed in Japanese Patent Application Laid-Open No. 2011-059406 may not be able to obtain an image with proper exposure in some cases.

### SUMMARY

A control apparatus according to one aspect of the present disclosure is configured to control a plurality of illumination apparatuses each having a first light emitter and a second light emitter. The control apparatus includes one or more memories storing instructions, and one or more processors that, upon execution of the instructions, operate to communicate with each of the plurality of illumination apparatuses, and set a light amount of the first light emitter of each of the plurality of illumination apparatuses. The one or more processors may operate to acquire a first light amount ratio of reflected light from an object obtained by causing first light emitters of the plurality of illumination apparatuses to emit light with the light amounts, or set a light amount ratio of the second light emitters of the plurality of illumination apparatuses using the light amounts of the first light emitters of the plurality of illumination apparatuses. A control method corresponding to the above control apparatus also constitutes another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a block diagram of an imaging system according to a first embodiment.

FIG. 2 is a diagram illustrating an imaging system according to a comparative example.

FIG. 3 is a diagram illustrating the imaging system according to the first embodiment.

FIG. 4 is a flowchart illustrating a control method according to the first embodiment.

FIG. 5 is a flowchart illustrating a control method according to the first embodiment.

FIG. 6 is a diagram illustrating an imaging system according to a second embodiment.

FIG. 7 is a flowchart illustrating a control method according to the second embodiment.

FIG. 8 is a flowchart illustrating a control method for an automatic light control imaging request (request for imaging under automatic light control) according to the second embodiment.

FIG. 9 is a flowchart illustrating a control method according to a third embodiment.

FIG. 10 is a flowchart illustrating a control method according to a fourth embodiment.

FIG. 11 is a flowchart illustrating a control method according to a fifth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure.

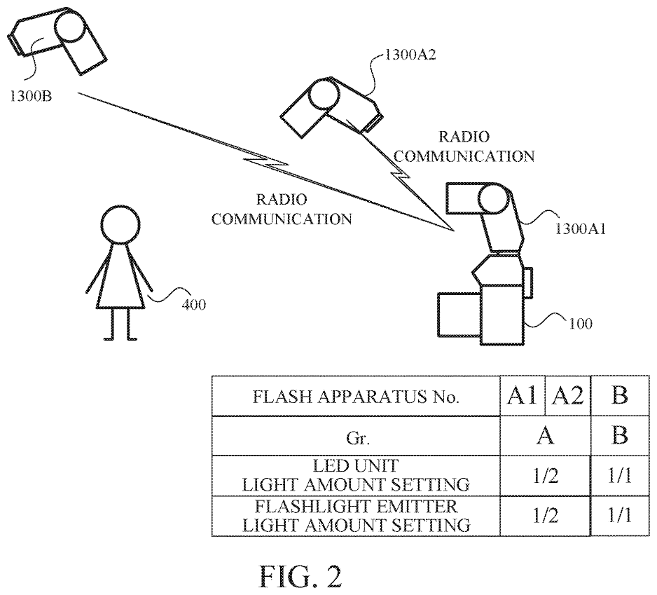

First, a comparative example common to the respective embodiments will be described with reference to FIG. 2. FIG. 2 is an explanatory diagram illustrating an example of an imaging system according to a comparative example. The imaging system includes an image pickup apparatus 100 and flash apparatuses 1300A1, 1300A2, and 1300B. By operating the flash apparatus 1300A1, a light emission amount setting for flashlight emission by a discharge tube is transmitted to the flash apparatuses 1300A1, 1300A2, and 1300B. In response, the flash apparatuses 1300A1, 1300A2, and 1300B emit light from LED modeling lights in association with the flashlight emission setting of the discharge tube. Thereby, shading intended by the user can be modeled. In a configuration such as this comparative example, in which light emission from the LED modeling lights is performed in association with the light emission amount setting of flashlight emission by the discharge tube, the flashlight emission amount by the discharge tube differs from the light amount of the LED modeling light. Thus, when flashlight emission by the discharge tube is performed, the amount of light incident on an object 400 may differ from the amount of light intended by the user, and thus a properly exposed image may not be obtained.

Accordingly, each embodiment is configured to obtain a properly exposed image in which shading on an object intended by the user are confirmed, without impairing real-time performance.

Each embodiment will be described in detail below.

### First Embodiment

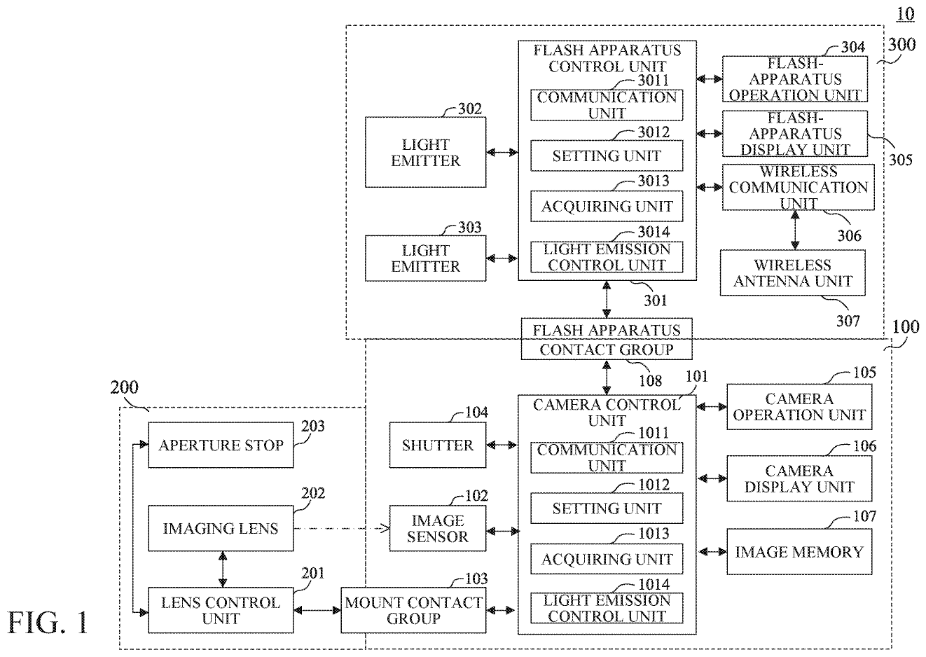

FIG. 1 is a block diagram illustrating a configuration of an imaging system (illumination system) 10 according to a first embodiment. The imaging system 10 includes an image pickup apparatus (camera body) 100, a lens apparatus 200, and a flash apparatus (sender flash apparatus) 300. The lens apparatus 200 is an interchangeable lens attachable to and detachable from the image pickup apparatus 100. The image pickup apparatus 100 and the lens apparatus 200 are mechanically and electrically connected via a mount contact group 103. However, the present embodiment is not limited to this example, and the image pickup apparatus 100 and the lens apparatus 200 may be integrated. The flash apparatus 300 is detachably attached to an upper surface of the image pickup apparatus 100. The image pickup apparatus 100 and the flash apparatus 300 are electrically connected via a flash apparatus contact group 108.

Although not illustrated in FIG. 1, the imaging system 10 includes, in addition to the flash apparatus 300 attached to the image pickup apparatus 100, at least one flash apparatus (receiver flash apparatus) disposed separately from the image pickup apparatus 100 and capable of wireless communication with the flash apparatus (sender flash apparatus) 300.

A camera control unit 101 is a microcomputer that controls operations of respective units in the image pickup apparatus 100. In the present embodiment, the camera control unit 101 includes a communication unit 1011, a setting unit 1012, an acquiring unit 1013, and a light emission control unit 1014. The camera control unit 101 includes one or more memories storing instructions, and one or more processors that, upon execution of the instructions, operate to serve as the communication unit 1011, the setting unit 1012, the acquiring unit 1013, and the light emission control unit 1014. An image sensor 102 is an image sensor including a photoelectric conversion element such as a CMOS sensor, and includes an infrared cut filter, a low-pass filter, and the like.

A shutter 104 is disposed between the image sensor 102 and an imaging lens 202, and closes to shield light to the image sensor 102 during a non-imaging period in accordance with an instruction from the camera control unit 101, and opens during live-view or imaging to guide incident light that has passed through the lens apparatus 200 to the image sensor 102.

A camera operation unit 105 includes an operation member operable by a user, detects a user operation performed via a button, a switch, a dial, and a connected device attached to the image pickup apparatus 100, and transmits a signal corresponding to an operation instruction to the camera control unit 101. The camera operation unit 105 outputs to the camera control unit 101 an instruction signal (SW1signal) generated when a release button is half-pressed, and an instruction signal (SW2 signal) generated when the release button is fully pressed.

A camera display unit 106 displays imaging information and a captured image in accordance with an instruction from the camera control unit 101.

Based on output signals from the camera operation unit 105, the camera control unit 101 controls operations of the image pickup apparatus 100. In a case where the output signal is the SW1 signal, the camera control unit 101 drives the image sensor 102 to perform imaging. The camera control unit 101 repeatedly performs photometric (light metering) control for measuring the luminance of an object based on an imaging result, and determines a shutter speed, an aperture value (F-number), and an ISO sensitivity (ISO speed) to be used during imaging based on the photometric result. The shutter speed, the aperture value, and the ISO sensitivity to be used during imaging will be collectively referred to as exposure control values. The exposure control values determined by the camera control unit 101 are displayed on a screen of the camera display unit 106. In a case where the output signal from the camera operation unit 105 is the SW2 signal, the camera control unit 101 drives an aperture stop 203 in the imaging lens 202, sets the sensitivity (ISO sensitivity) of the image sensor 102, and controls the shutter 104 to irradiate the image sensor 102 with light. The camera control unit 101 displays a captured image on the screen of the camera display unit 106 in accordance with image data acquired from the image sensor 102, and writes the image data into an image memory 107.

Next, a configuration of the lens apparatus 200 will be described. A lens control unit 201 is a microcomputer that controls operations of respective units of the lens apparatus 200. The imaging lens 202 includes a plurality of lenses and forms an object image on the image sensor 102. The imaging lens 202 includes the aperture stop 203 for adjusting a light amount and a focus lens (not illustrated) for focusing. The lens control unit 201 adjusts the amount of light incident on the image pickup apparatus 100 and perform focusing in accordance with instructions from the camera control unit 101 via control through the mount contact group 103.

Next, a configuration of the flash apparatus (sender flash apparatus) 300 will be described. A flash-apparatus control unit 301 is a microcomputer that controls operations of respective units of the flash apparatus 300. The flash-apparatus control unit 301 includes a communication unit 3011, a setting unit 3012, an acquiring unit 3013, and a light emission control unit 3014. The flash-apparatus control unit 301 includes one or more memories storing instructions, and one or more processors that, upon execution of the instructions, operate to serve as the communication unit 3011, the setting unit 3012, the acquiring unit 3013, and the light emission control unit 3014. The flash-apparatus control unit 301 can communicate with the camera control unit 101 via the flash apparatus contact group 108, receive light emission control instructions and image pickup apparatus information from the image pickup apparatus 100, and transmit flash apparatus information.

A light emitter (flashlight emitter, second light emitter) 302 includes a discharge tube, a light emitting capacitor, a light emission circuit, and light emission optical system, and is capable of emitting flashlight.

A light emitter (LED unit, first light emitter) 303 includes an LED light source including a light-emitting diode (LED) and is capable of emitting light more continuously than the light emitter 302. The light emitter 303 emits light or stops emitting light in accordance with an instruction from the flash-apparatus control unit 301, and can be used as a modeling light source, an autofocus (AF) assist light source, or a moving image light. In the present embodiment, the light emitter 303 includes an LED; however, the configuration is not limited to this example, and another continuously emitting light source may be employed.

A flash-apparatus operation unit 304 includes an operation member operable by a user, detects an operation performed via a button, a dial, or a switch attached to the flash apparatus 300, and transmits a signal corresponding to an operation instruction to the flash-apparatus control unit 301.

A flash-apparatus display unit 305 displays light emission settings, radio settings, and operation states of the flash apparatus 300 in accordance with instructions from the flash-apparatus control unit 301.

A wireless communication unit 306 transmits and receives wireless communication information to and from a receiver flash apparatus (not illustrated) wirelessly connected via a wireless antenna unit 307. The flash-apparatus control unit 301 can transmit and receive control information, such as information relating to light emission control of the light emitters 302 and 303, to and from the receiver flash apparatus via the wireless communication unit 306 and the wireless antenna unit 307.

A receiver flash apparatus is a flash apparatus that is not mechanically attached to the image pickup apparatus 100. The basic configuration of the receiver flash apparatus is common to that of the sender flash apparatus 300, and thus a description thereof will be omitted. The receiver flash apparatus receives communication from the flash apparatus (sender flash apparatus) 300 via a receiver wireless communication unit (not illustrated), and controls receiver light emitters (not illustrated) corresponding to the light emitters 302 and 303 in accordance with instructions from a receiver flash-apparatus control unit (not illustrated). In the present embodiment, the flash apparatus 300 includes the light emitters 302 and 303; however, the configuration is not limited to this example, and an image pickup apparatus including a light emitter, or a communication apparatus not including a light emitter, may be used instead.

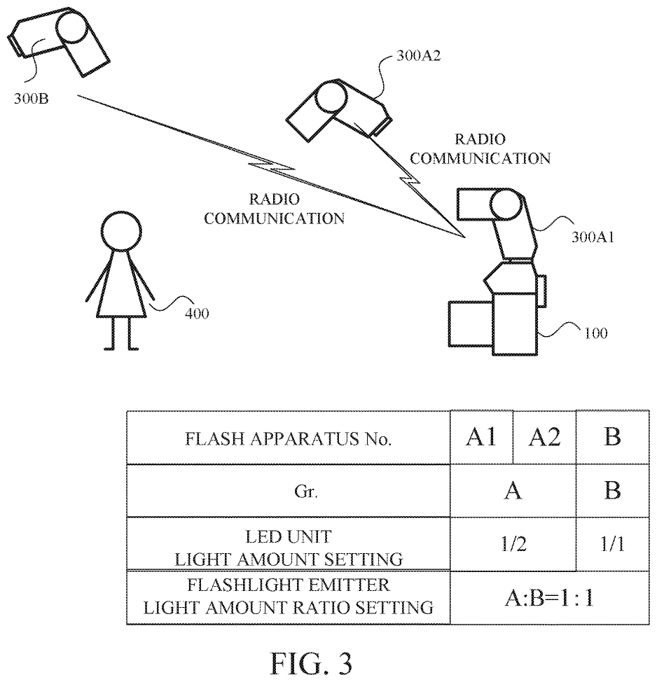

Next, the operations of the imaging system 10 according to the present embodiment will be described with reference to FIG. 3. FIG. 3 is an explanatory diagram illustrating an example of the imaging system 10 according to the present embodiment. The flash apparatuses 300A1, 300A2, and 300B form a Personal Area Network (PAN) via the wireless communication unit 306 and are capable of transmitting and receiving information. The flash apparatus 300A1 is a sender flash apparatus that issues light emission commands to receiver flash apparatuses. The flash apparatuses 300A2 and 300B are receiver flash apparatuses that emit light in response to commands from the flash apparatus 300A1.

The flash apparatus 300A1 is controlled by a flash-apparatus control unit 301A1, the flash apparatus 300A2 is controlled by a flash-apparatus control unit 301A2, and the flash apparatus 300B is controlled by a flash-apparatus control unit 301B. The sender flash apparatus can store light emission amount settings of the light emitter 303 of the receiver flash apparatuses, and can select a light emission mode and set light emission amounts of the light emitter 303 for each light emission group (Gr) via the flash-apparatus operation unit 304. In the present embodiment, the light emission mode is a group mode; however, any known light emission mode may be used.

The group mode is a function that enables a plurality of flash apparatuses 300 registered in the same group to be controlled in the same manner in accordance with commands issued from the sender flash apparatus to the group. For example, a light emission amount of the light emitter 303 can be set for each light emission group. In the present embodiment, the light emission amount set in the light emitter 303 of each group by the flash apparatus (sender flash apparatus) 300A1 is 1/2 for group A (first group) and 1/1 for group B (second group). In the present embodiment, the light emission group of the flash apparatus (sender flash apparatus) 300A1 is group A, the light emission group of the flash apparatus (receiver flash apparatus) 300A2 is group A, and the light emission group of the flash apparatus (receiver flash apparatus) 300B is group B. The sender flash apparatus can store a setting of a light amount ratio on an object surface by the light emitter (flashlight emitter) 302 of the receiver flash apparatus, communicate with the camera control unit 101, and cause the receiver flash apparatuses to emit light with the set light amount ratio.

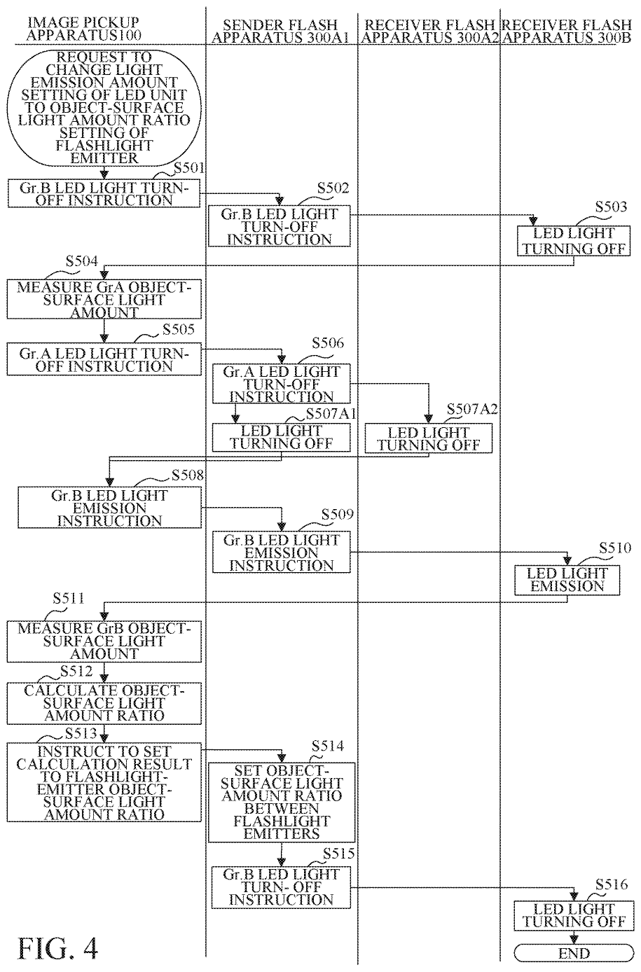

Next, with reference to FIG. 4, an example of a control flow performed when a request is made, by an operation of the camera operation unit 105, to change a light emission amount setting of the light emitter (LED unit) 303 to an object-surface light amount ratio setting of the flashlight emitter will be described. FIG. 4 is a flowchart illustrating control for requesting a change from a light emission amount setting of the LED unit to an object-surface light amount ratio setting of the flashlight emitter. In the present embodiment, the control flow starts from a state in which the light emitter 303 of the flash apparatuses in each group is emitting light according to the light emission amount settings of the light emitters 303 illustrated in FIG. 3, with the camera operation unit 105 serving as a trigger.

When a change request is made via the camera operation unit 105 to change the light emission amount setting of the LED unit to an object-surface light amount ratio setting of the flashlight emitter, the flow proceeds to step S501. In step S501, the camera control unit 101 issues an instruction to the flash-apparatus control unit 301A1 to turn off the LED of group B. In step S502, the flash-apparatus control unit 301A1 sends a turn-off instruction to the flash-apparatus control unit 301B. In step S503, the flash-apparatus control unit 301B turns off the light emitter 303B. Thereby, only light from the light emitters 303A1 and 303A2 of group A is irradiated onto the object 400.

In step S504, the camera control unit 101 measures reflected light, using the image sensor 102, from the light emitters 303A1 and 303A2 of group A. In step S505, the camera control unit 101 issues a turn-off instruction for the light emitters 303A1 and 303A2 of group A to the flash-apparatus control unit 301A1.

In step S506, the flash-apparatus control unit 301A1 sends a turn-off instruction to itself and to the flash-apparatus control unit 301A2. In step S507A1, the flash-apparatus control unit 301A1 turns off the light emitter 303A1. In step S507A2, the flash-apparatus control unit 301A2 turns off the light emitter 303A2.

In step S508, the camera control unit 101 issues an instruction to the flash-apparatus control unit 301A1 to turn on the light emitter 303B of group B. In step S509, the flash-apparatus control unit 301A1 sends a light emission instruction for the light emitter 303B to the flash-apparatus control unit 301B.

In step S510, the flash-apparatus control unit 301B causes the light emitter 303B to emit light. Thereby, only light from the light emitter 303B of group B is irradiated onto the object 400 illustrated in FIG. 3.

In step S511, the camera control unit 101 measures reflected light from the light emitter 303B of group B using the image sensor 102. In step S512, the camera control unit 101 converts reflected light from the light emitters 303A1 and 303A2 of group A and reflected light from the light emitter 303B of group B into a ratio, that is, acquires a light amount ratio between the reflected light from the light emitters 303A1 and 303A2 and the reflected light from the light emitter 303B. In the example of FIG. 3, in a case where the distances from the object 400 to the flash apparatuses 300A1 and 300A2 of group A and the distance from the object 400 to the flash apparatus 300B of group B are equal to each other, the reflected light of group A is 1/2+1/2=1, and the reflected light of group B is 1. Therefore, the object-surface light amount ratio between the flashlight emitters of group A and group B is set to 1:1 (A:B=1:1).

In step S513, the camera control unit 101 instructs the flash-apparatus control unit 301A1 to set the object-surface light amount ratio between the flashlight emitters of groups A and B. In step S514, the flash-apparatus control unit 301A1 sets the light amount ratio between groups A and B in itself. In step S515, the flash-apparatus control unit 301A1 sends a turn-off instruction to the flash-apparatus control unit 301B. In step S516, the flash-apparatus control unit 301B turns off the light emitter 303B.

Thereby, the camera control unit 101 can set an object-surface light amount ratio between the flashlight emitters of the sender flash apparatus. Although an example with two groups, group A and group B, has been described in the present embodiment, the present embodiment is also applicable to three or more groups. In addition, the order of light emission and turn-off for setting a state in which only light from a single group of the light emitter 303 is irradiated is not limited to the order described above.

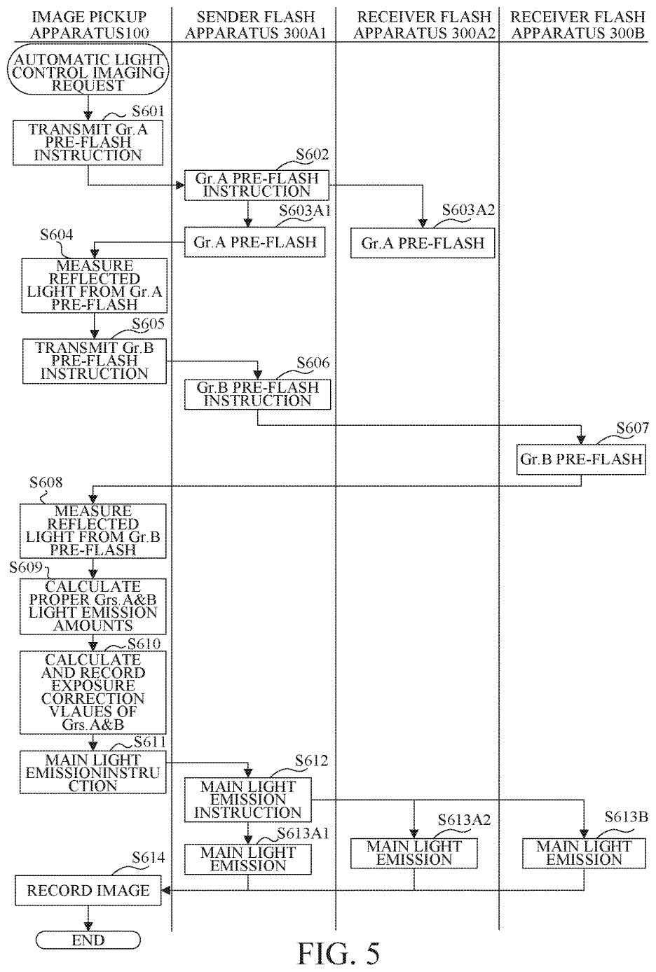

Next, with reference to FIG. 5, an example of a control flow performed when an automatic light control imaging request is made by an operation of the camera operation unit 105 in the present embodiment will be described. FIG. 5 is a flowchart illustrating control for an automatic light control imaging request. In the present embodiment, the control flow starts from a state in which the object-surface light amount ratio between the flashlight emitters has been set in the flash apparatus (sender flash apparatus) 300A1 by the control illustrated in FIG. 4, with the camera operation unit 105 serving as a trigger. When an automatic light control imaging request is made via the camera operation unit 105, the flow proceeds to step S601. In step S601, the camera control unit 101 issues a pre-flash (preliminary light emission) instruction for group A to the flash-apparatus control unit 301A1.

In step S602, the flash-apparatus control unit 301A1 issues a pre-flash instruction to itself and to the flash-apparatus control unit 301A2. In step S603A1, the flash-apparatus control unit 301A1 causes the light emitter 302A1 to perform pre-flash. In step S603A2, the flash-apparatus control unit 301A2 causes the light emitter 302A2 to perform pre-flash. In step S604, the camera control unit 101 measures reflected light from the pre-flash of group A using the image sensor 102.

In step S605, the camera control unit 101 issues a pre-flash instruction for group B to the flash-apparatus control unit 301A1. In step S606, the flash-apparatus control unit 301A1 issues a pre-flash instruction to the flash-apparatus control unit 301B. In step S607, the flash-apparatus control unit 301B causes the light emitter 302B to perform pre-flash. In step S608, the camera control unit 101 measures reflected light from the pre-flash of group B using the image sensor 102.

In step S609, the camera control unit 101 calculates a proper light amount for main light emission for each group based on reflected light from the pre-flash of group A and reflected light from the pre-flash of group B.

In step S610, the camera control unit 101 adds, to the main light emission amounts, exposure correction values of groups A and B corresponding to a light amount ratio (setting value) previously transmitted from the flash-apparatus control unit 301A1, calculates a light emission amount for each group, and stores the calculated light emission amounts. In the example of FIG. 3, the set value of the light amount ratio (A:B) between groups A and B is 1:1. Therefore, proper light amounts when each group emits light independently are calculated, and a light amount correction amount for group A of log₂(1/2)=−1F and a light amount correction amount for group B of log₂(1/2)=−1F are added to the light emission amounts of the respective groups, thereby calculating a proper light amount ratio.

In step S611, the camera control unit 101 issues a main light emission instruction with the calculated light emission amounts of the respective groups to the flash-apparatus control unit 301A1. In step S612, the flash-apparatus control unit 301A1 issues a main light emission instruction with the light emission amounts of the respective groups to itself, the flash-apparatus control unit 301A2, and the flash-apparatus control unit 301B. In step S613A1, the flash-apparatus control unit 301A1 causes the light emitter 302A1 to perform main light emission. In step S613A2, the flash-apparatus control unit 301A2 causes the light emitter 302A2 to perform main light emission. In step S613B, the flash-apparatus control unit 301B causes the light emitter 302B to perform main light emission. In step S614, the camera control unit 101 acquires an image using the image sensor 102 and writes image data to the image memory 107.

Thereby, the camera control unit 101 can acquire an automatically light-controlled image using a light amount ratio among the flashlight emitters instructed by the sender flash apparatus.

### Second Embodiment

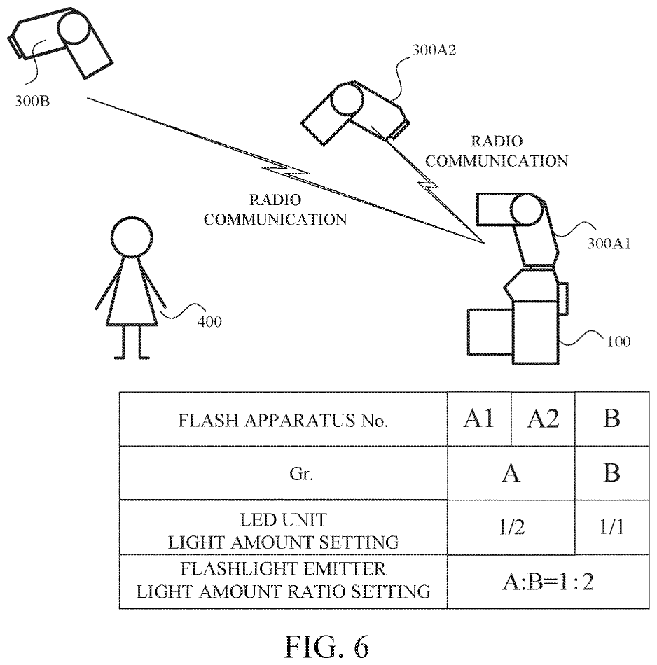

Next, a second embodiment will be described with reference to FIGS. 6 to 8. In the first embodiment, after a request is made by the operation of the camera operation unit 105 to change the light emission amount settings of the LED unit to an object-surface light amount ratio setting of the flashlight emitter, an automatic light control imaging request is made by the operation of the camera operation unit 105, thereby acquiring an automatically light-controlled image using the object-surface light amount ratio. In contrast, in the present embodiment, after a request is made by an operation of the flash-apparatus operation unit 304 to change a light emission amount setting of the LED unit to a light emission amount ratio setting of the flashlight emitter, an automatic light control imaging request is made by an operation of the camera operation unit 105, thereby acquiring an automatically light-controlled image using a flashlight-emitter light emission amount ratio. The basic configuration according to the present embodiment is common to that of FIG. 1 of the first embodiment, and thus a description thereof will be omitted.

FIG. 6 is an explanatory diagram illustrating an example of the imaging system 10 in the present embodiment. The flash apparatuses 300A1, 300A2, and 300B form a PAN via the wireless communication unit 306 and can transmit and receive information. The flash apparatus 300A1 is a sender flash apparatus that issues a light emission command to receiver flash apparatuses. The flash apparatuses 300A2 and 300B are receiver flash apparatuses that emit light in response to a command from the sender flash apparatus.

The flash apparatus 300A1 is controlled by a flash-apparatus control unit 301A1, the flash apparatus 300A2 is controlled by a flash-apparatus control unit 301A2, and the flash apparatus 300B is controlled by a flash-apparatus control unit 301B. The sender flash apparatus can store a light emission amount setting of the light emitters 303 of the receiver flash apparatus, and select a light emission mode by using the flash-apparatus operation unit 304 and to set a light emission amount of the light emitter 303 for each light emission group (Gr.). In the present embodiment, the light emission mode is a group mode; however, any light emission mode may be employed as long as it is a known method.

The group mode is a function in which a plurality of flash apparatuses 300 are registered in the same group, thereby enabling the plurality of flash apparatuses 300 registered in the group to be similarly controlled in accordance with commands issued from the sender to the group. For example, a light emission amount of the light emitter 303 can be set for each light emission group. In the present embodiment, the light emission amount of the light emitter 303 for group A is set to 1/2, and the light emission amount for group B is set to 1/1, relative to each group of the flash apparatus 300A1. The light emission group of the flash apparatus 300A1 is group A, the light emission group of the flash apparatus 300A2 is group A, and the light emission group of the flash apparatus 300B is group B. The sender flash apparatus can store a flashlight-emitter light emission amount ratio setting of the light emitters 302 of the receiver flash apparatuses, and is configured to communicate with the camera control unit 101 to cause the receiver flash apparatuses to emit light according to the flashlight-emitter light emission amount ratio.

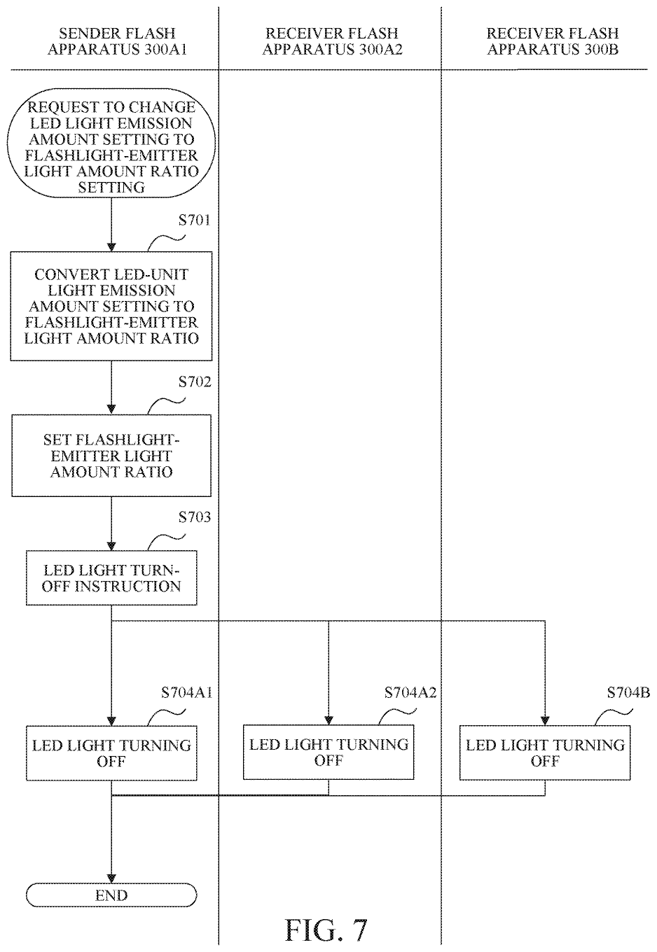

Next, with reference to FIG. 7, an example of a control flow performed when a request is made, by the operation of the flash-apparatus operation unit 304 of the flash apparatus (sender flash apparatus) 300A1, to change a light emission amount setting of the LED unit to an object-surface light amount ratio setting of the flashlight emitter in the present embodiment will be described. FIG. 7 is a flowchart illustrating control for requesting a change from a light emission amount setting of the LED unit to an object-surface light amount ratio setting of the flashlight emitter. In the present embodiment, the control flow starts, as a trigger, from the operation of the flash-apparatus operation unit 304 of the flash apparatus 300A1 while the light emitter 303 of the flash apparatus in each group is emitting light according to the light emission amount setting illustrated in FIG. 6. In the present embodiment, the control flow may alternatively start from communication from the camera control unit 101 to the flash-apparatus control unit 301A1 via the flash apparatus contact group 108 by operating the camera operation unit 105.

When a request is made via the flash-apparatus operation unit 304 to change a light emission amount setting of the LED unit to an object-surface light amount ratio setting of the flashlight emitter, the flow proceeds to step S701. In step S701, the flash-apparatus control unit 301A1 converts the LED light emission amount settings into a flashlight-emitter light amount ratio. In the example of FIG. 6, since the light emission amount of group A is 1/2 and the light emission amount of group B is 1/1, the light amount ratio of group A to group B is 1:2. In step S702, the flash-apparatus control unit 301A1 sets the light amount ratio.

In step S703, the flash-apparatus control unit 301A1 sends a turn-off instruction to the flash-apparatus control units 301A2 and 301B. In step S704A1, the flash-apparatus control unit 301A1 turns off the light emitter 303A1. In step S704A2, the flash-apparatus control unit 301A2 turns off the light emitter 303A2. In step S704B, the flash-apparatus control unit 301B turns off the light emitter 303B.

Thereby, the sender flash-apparatus control unit can set an object-surface light amount ratio between the flashlight emitters in the sender flash apparatus. Although an example with two groups, group A and group B, has been described in the present embodiment, the present embodiment is also applicable to three or more groups.

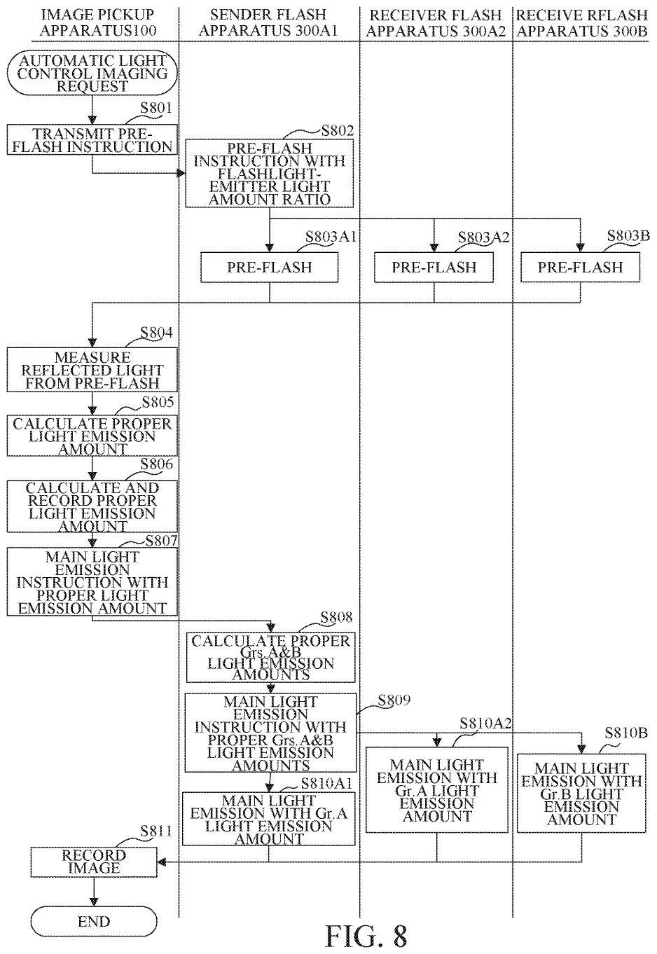

Next, with reference to FIG. 8, an example of a control flow performed when an automatic light control imaging request is made by the operation of the camera operation unit 105 will be described. FIG. 8 is a flowchart illustrating control for an automatic light control imaging request. In the present embodiment, the control flow starts, with the camera operation unit 105 serving as a trigger, from a state in which the object-surface light amount ratio between the flashlight emitter has been set in the flash apparatus (sender flash apparatus) 300A1 by the control illustrated in FIG. 6. When an automatic light control imaging request is made via the camera operation unit 105, the flow proceeds to step S801. In step S801, the camera control unit 101 issues a pre-flash instruction to the flash-apparatus control unit 301A1.

In step S802, the flash-apparatus control unit 301A1 issues pre-flash instructions to itself, the flash-apparatus control unit 301A2, and the flash-apparatus control unit 301B according to the flashlight-emitter light amount ratio. In the example of FIG. 6, light emission instructions are issued with light emission amounts corresponding to a light amount ratio of 1:2 between group A and group B. In step S803A1, the flash-apparatus control unit 301A1 causes the light emitter 302A1 to perform pre-flash with the instructed light emission amount. In step S803A2, the flash-apparatus control unit 301A2 causes the light emitter 302A2 to perform pre-flash with the instructed light emission amount. In step S803B, the flash-apparatus control unit 301B causes the light emitter 302B to perform pre-flash with the instructed light emission amount.

In step S804, the camera control unit 101 measures reflected light from the pre-flash using the image sensor 102. In step S805, the camera control unit 101 calculates a proper light amount based on the reflected light. In step S806, the camera control unit 101 records the calculated proper light amount.

In step S807, the camera control unit 101 issues a main light emission instruction to the flash-apparatus control unit 301A1. In step S808, the flash-apparatus control unit 301A1 adds correction values calculated from the flashlight-emitter light amount ratio to the instructed light emission values, and calculates proper main light emission amounts for group A and group B. In the example of FIG. 6, the set value of the flashlight-emitter light amount ratio between group A and group B is 1:2. Therefore, a light amount correction amount for group A of log₂(1/3)=−1.58F and a light amount correction amount for group B of log₂(2/3)=−0.58F are added to the light emission amounts of the respective groups, thereby calculating proper light amounts.

In step S809, the flash-apparatus control unit 301A1 issues main light emission instructions with the calculated proper light emission amounts of the respective groups to itself, the flash-apparatus control unit 301A2, and the flash-apparatus control unit 301B. In step S810A1, the flash-apparatus control unit 301A1 causes the light emitter 302A1 to perform main light emission with the instructed light emission amount. In step S810A2, the flash-apparatus control unit 301A2 causes the light emitter 302A2 to perform main light emission with the instructed light emission amount. In step S810B, the flash-apparatus control unit 301B causes the light emitter 302B to perform main light emission with the instructed light emission amount. In step S811, the camera control unit 101 acquires an image using the image sensor 102 and writes image data to the image memory 107.

Thereby, the camera control unit 101 can acquire an automatically light-controlled image using a flashlight-emitter light amount ratio of the sender flash apparatus.

### Third Embodiment

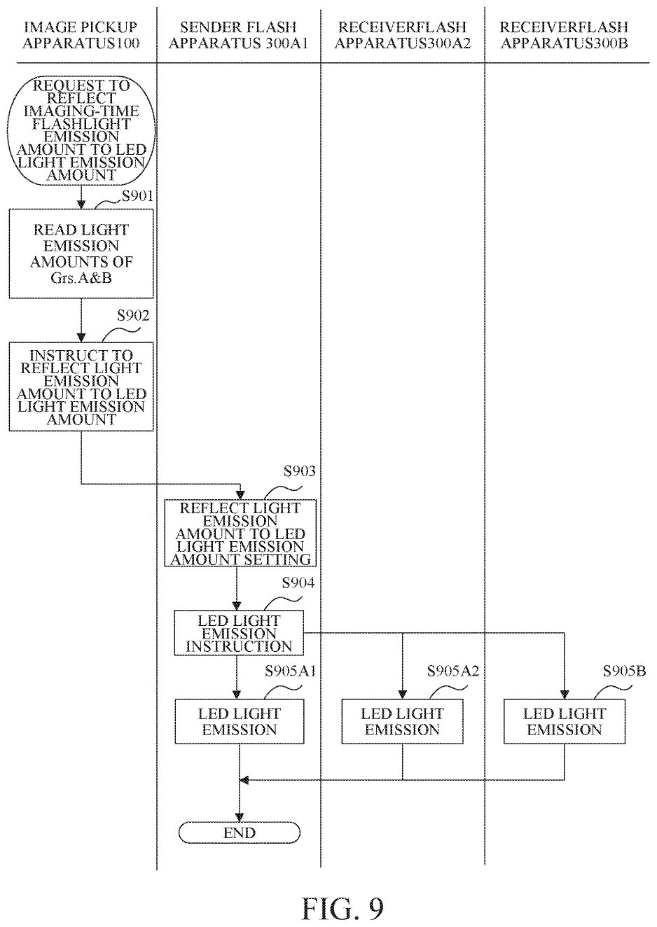

Next, a third embodiment will be described with reference to FIG. 9. FIG. 9 is a flowchart illustrating control performed when a request is made, by the operation of the camera operation unit 105, to reflect a flashlight emission amount during imaging to an LED light emission amount, that is, a request to reflect an imaging-time flashlight emission amount to an LED light emission amount or a request to set an LED light emission amount corresponding to the flashlight emission amount during imaging.

In the first embodiment, after a request is made by the operation of the camera operation unit 105 to change an LED unit light emission amount setting to a light amount ratio setting, an automatic light control imaging request is made by the operation of the camera operation unit 105, thereby acquiring an automatically light-controlled image using a light amount ratio. In contrast, the present embodiment performs control to reflect an imaging-time flashlight emission amount to an LED light emission amount according to the operation of the camera operation unit 105. The basic configuration and operation of the present embodiment are common to those of FIGS. 1, 3, 4, and 5 of the first embodiment, and thus a description thereof will be omitted.

In the present embodiment, the control flow starts, with the camera operation unit 105 serving as a trigger, from a state in which an automatically light-controlled image has been acquired by the control illustrated in FIG. 5 after a light amount ratio at an arbitrary object surface has been set. When a request to reflect an imaging-time flashlight emission amount to an LED light emission amount is made via the camera operation unit 105, the flow proceeds to step S901.

In step S901, the camera control unit 101 reads out the main light emission amounts of the respective groups recorded in step S610 of FIG. 5. In step S902, the camera control unit 101 converts the main light emission amounts of the respective groups into LED light emission amounts, and instructs the flash-apparatus control unit 301A1 to set LED light emission amounts for the respective groups.

In step S903, the flash-apparatus control unit 301A1 sets the LED light emission amounts for the respective groups. In step S904, the flash-apparatus control unit 301A1 sends light emission instructions with the LED light emission amount settings of the respective groups to itself, the flash-apparatus control unit 301A2, and the flash-apparatus control unit 301B.

In step S905A1, the flash-apparatus control unit 301A1 causes the light emitter 303A1 to emit light with the instructed light emission amount. In step S905A2, the flash-apparatus control unit 301A2 causes the light emitter 303A2 to emit light with the instructed light emission amount. In step S905B, the flash-apparatus control unit 301B causes the light emitter 303B to emit light with the instructed light emission amount.

Thereby, the imaging-time flashlight emission amount is reflected to the LED light emission amount of the flash-apparatus control unit 301A1, and shading during automatic light control imaging can be confirmed in real time.

### Fourth Embodiment

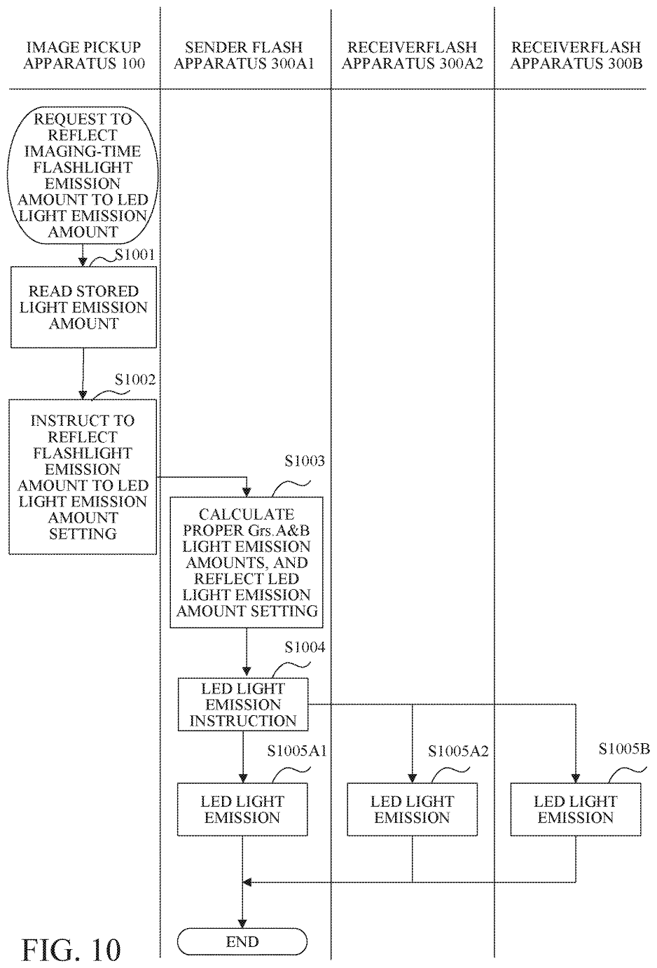

Next, a fourth embodiment will be described with reference to FIG. 10. FIG. 10 is a flowchart illustrating control performed when a request is made, by the operation of the camera operation unit 105, to reflect a flashlight emission amount during imaging to an LED light emission amount, that is, a request to reflect an imaging-time flashlight emission amount to an LED light emission amount.

In the second embodiment, after a request is made by the operation of the flash-apparatus operation unit 304 in the sender flash apparatus to change a light emission amount of the LED unit to a flashlight-emitter light amount ratio, an automatic light control imaging request is made by an operation of the camera operation unit 105, thereby acquiring an automatically light-controlled image using a light amount ratio. In contrast, the present embodiment performs control to reflect an imaging-time flashlight emission amount to an LED light emission amount according to the operation of the camera operation unit 105. The basic configuration and operation of the present embodiment are common to those of FIGS. 1, 6, 7, and 8 of the second embodiment, and thus a description thereof will be omitted.

In the present embodiment, the control flow starts, with the camera operation unit 105 serving as a trigger, from a state in which an automatically light-controlled image has been acquired by the control illustrated in FIG. 8 after a light amount ratio at an arbitrary object surface has been set. When a request to reflect an imaging-time flashlight emission amount to an LED light emission amount is made via the camera operation unit 105, the flow proceeds to step S1001.

In step S1001, the camera control unit 101 reads out the main light emission amount recorded in step S806 of FIG. 8. In step S1002, the camera control unit 101 transmits the main light emission amount to the flash-apparatus control unit 301A1 and instructs the flash-apparatus control unit 301A1 to reflect the flashlight emission amount to an LED light emission amount setting.

In step S1003, the flash-apparatus control unit 301A1 calculates LED light emission amounts for the respective groups based on the received main light emission amount, and reflects the calculated values to the LED light emission amount settings. In the example illustrated in FIG. 6, the set value of the flashlight emission amount ratio between group A and group B is 1:2. Therefore, a value obtained by adding a light amount correction amount of log₂(1/3)=−1.58 F for group A and a light amount correction amount of log₂(2/3)=−0.58 F for group B to the respective light emission amounts is reflected to the LED light emission amount settings.

In step S1004, the flash-apparatus control unit 301A1 sends light emission instructions with the LED light emission amount settings of the respective groups to itself, the flash-apparatus control unit 301A2, and the flash-apparatus control unit 301B.

In step S1005A1, the flash-apparatus control unit 301A1 causes the light emitter 303A1 to emit light with the instructed light emission amount. In step S1005A2, the flash-apparatus control unit 301A2 causes the light emitter 303A2 to emit light with the instructed light emission amount. In step S1005B, the flash-apparatus control unit 301B causes the light emitter 303B to emit light with the instructed light emission amount.

Thereby, the imaging-time flashlight emission amount is reflected to the LED light emission amount of the flash-apparatus control unit 301A1, and shading during automatic light control imaging can be confirmed in real time.

### Fifth Embodiment

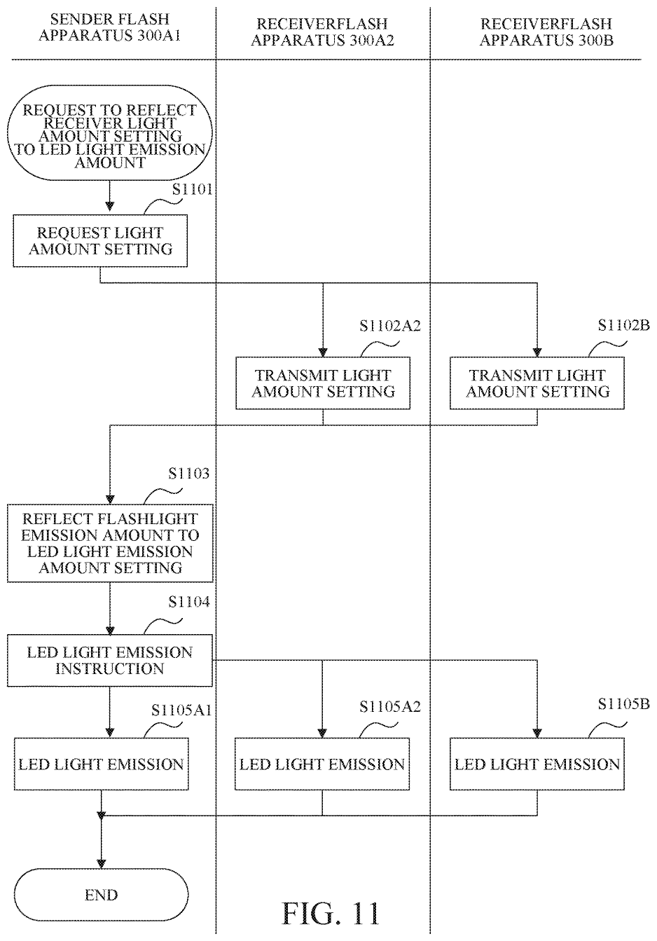

Next, a fifth embodiment will be described with reference to FIG. 11. The present embodiment performs control when a request is made, by an operation of the flash-apparatus operation unit 304 of the flash apparatus (sender flash apparatus) 300A1, to reflect a light amount setting of a receiver flash apparatus to an LED light emission amount. The basic configuration according to the present embodiment is common to that of FIGS. 1 and 6 described in the second embodiment, and thus description thereof will be omitted.

FIG. 11 is a flowchart illustrating control performed when a request is made, by an operation of the flash-apparatus operation unit 304 of the flash apparatus 300, to reflect a receiver light amount setting to an LED light emission amount. In the present embodiment, the control flow starts, with an operation of the flash-apparatus operation unit 304 serving as a trigger, after arbitrary flashlight-emitter light emission amounts have been set for the flash-apparatus control units 301A1, 301A2, and 301B illustrated in FIG. 6. When a request to reflect the LED light emission amount to the receiver light amount setting is made by operating the flash-apparatus operation unit 304, the flow proceeds to step S1101.

In step S1101, the flash-apparatus control unit 301A1 in the sender flash apparatus issues a request for transmission of light amount settings to the flash-apparatus control units 301A2 and 301B of the receiver flash apparatuses. In step S1102A2, the flash-apparatus control unit 301A2 transmits its light amount setting to the flash-apparatus control unit 301A1. In step S1102B, the flash-apparatus control unit 301B transmits its light amount setting to the flash-apparatus control unit 301A1.

In step S1103, the flash-apparatus control unit 301A1 converts the flashlight emission amount of each group into an LED light emission amount and reflects the converted values to the LED light emission amount settings. In step S1104, the flash-apparatus control unit 301A1 sends light emission instructions based on the LED light emission amount settings of each group to itself, the flash-apparatus control unit 301A2, and the flash-apparatus control unit 301B.

In step S1105A1, the flash-apparatus control unit 301A1 causes the light emitter 303A1 to emit light at the instructed light emission amount. In step S1105A2, the flash-apparatus control unit 301A2 causes the light emitter 303A2 to emit light at the instructed light emission amount. In step S1105B, the flash-apparatus control unit 301B causes the light emitter 303B to emit light at the instructed light emission amount.

Thereby, the setting of the receiver flashlight emitter is reflected to the LED light emission amount of the flash-apparatus control unit 301A1, and the shading corresponding to an arbitrary light amount setting of the receiver flashlight emitters can be confirmed in real time.

As described above, in each embodiment, a control apparatus (the camera control unit 101 or the flash-apparatus control unit 301) controls a plurality of illumination apparatuses (flash apparatuses 300: 300A1, 300A2, and 300B) each including a first light emitter (light emitter 303) and a second light emitter (light emitter 302). The control apparatus includes a communication unit 1011 or 3011, a setting unit 1012 or 3012, and an acquiring unit 1013 or 3013. The communication unit communicates with each of the plurality of illumination apparatuses. The setting unit sets a light amount of the first light emitter in each of the plurality of illumination apparatuses. The acquiring unit acquires a light amount ratio (a first light amount ratio) of reflected light from an object obtained by causing the first light emitters of the plurality of illumination apparatuses to emit light with the set light amounts.

The setting unit may set a light amount ratio (a second light amount ratio) between the second light emitters in the plurality of illumination apparatuses using the first light amount ratio (that is, changes the light amount of each second light emitter in the plurality of illumination apparatuses in accordance with the first light amount ratio). The second light amount ratio may be the same as or may be different from the first light amount ratio. In other words, the second light amount ratio may be a light amount ratio corresponding to the first light amount ratio.

The control apparatus includes a light emission control unit 1014 or 3014 that controls the first and second light emitters. The light emission control unit acquires a first light amount (a proper light amount) using reflected light from the object when the second light emitters of the plurality of illumination apparatuses perform pre-flash. The light emission control unit controls the second light emitters so as to perform main light emission with a second light amount obtained by adding, to the first light amount, a correction value corresponding to the second light amount ratio (a correction value for making a overall reflected light amount a proper light amount). The light emission control unit may set the second light amount for the first light emitters of the plurality of illumination apparatuses.

The plurality of illumination apparatuses may include at least one illumination apparatus belonging to a first group and at least one illumination apparatus belonging to a second group, and the first light amount ratio is a light amount ratio between the first group and the second group.

In each embodiment, the setting unit sets the light amount ratio of the second light emitters of the plurality of illumination apparatuses, using the light amounts of the first light emitters of the plurality of illumination apparatuses. The light emission control unit may acquire the first light amount using reflected light from the object when the second light emitters in the plurality of illumination apparatuses perform pre-flash with the light amount ratio set by the setting unit, and controls the second light emitters so as to perform main light emission with the first light amount. The light emission control unit may set the light amounts of the first light emitters in the plurality of illumination apparatuses using the first light amount. The light emission control unit may acquire, from each of the plurality of illumination apparatuses, the first light amount set for the first light emitter of each of the plurality of illumination apparatuses, and set the light amount ratio of the second light emitters of the plurality of illumination apparatuses using the acquired first light amounts.

At least a part of the functions of the camera control unit 101 may be provided to the flash-apparatus control unit 301. Alternatively, at least a part of the functions of the flash-apparatus control unit 301 may be provided to the camera control unit 101. The communication unit 1011 in the camera control unit 101 can communicate with a plurality of receiver flash apparatuses via the flash-apparatus control unit 301.

Each embodiment can provide a control apparatus, an illumination system, a control method, and a storage medium, each of which can acquire a properly exposed image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067702, filed on Apr. 16, 2025, which is hereby incorporated by reference herein in its entirety.

What is claimed is:

1. A control apparatus configured to control a plurality of illumination apparatuses each having a first light emitter and a second light emitter, the control apparatus comprising:
one or more memories storing instructions; and
one or more processors that, upon execution of the instructions, operate to:
communicate with each of the plurality of illumination apparatuses,
set a light amount of the first light emitter of each of the plurality of illumination apparatuses, and
acquire a first light amount ratio of reflected light from an object obtained by causing first light emitters of the plurality of illumination apparatuses to emit light with the light amounts.

2. The control apparatus according to claim 1, wherein the one or more processors operate to set a second light amount ratio among second light emitters of the plurality of illumination apparatuses using the first light amount ratio.

3. The control apparatus according to claim 2, wherein the one or more processors operate to:
control the first light emitters and the second light emitters,
acquire a first light amount using the reflected light from the object when the second light emitters of the plurality of illumination apparatuses perform preliminary light emission, and
control the second light emitters to perform main light emission with a second light amount obtained by adding, to the first light amount, a correction value corresponding to the second light amount ratio.

4. The control apparatus according to claim 2, wherein the one or more processors operate to:
control the first light emitters and the second light emitters,
acquire a first light amount using the reflected light from the object when the second light emitters of the plurality of illumination apparatuses perform preliminary light emission, and
set a second light amount obtained by adding, to the first light amount, a correction value corresponding to the second light amount ratio, to the first light emitter of each of the plurality of illumination apparatuses.

5. The control apparatus according to claim 1, wherein the plurality of illumination apparatuses include at least one illumination apparatus belonging to a first group and at least one illumination apparatus belonging to a second group, and
wherein the first light amount ratio is a light amount ratio between the first group and the second group.

6. A control apparatus configured to control a plurality of illumination apparatuses each having a first light emitter and a second light emitter, the control apparatus comprising:
one or more memories storing instructions; and
one or more processors that, upon execution of the instructions, operate to:
communicate with each of the plurality of illumination apparatuses,
set a light amount of the first light emitter of each of the plurality of illumination apparatuses, and
set a light amount ratio of the second light emitters of the plurality of illumination apparatuses using the light amounts of the first light emitters of the plurality of illumination apparatuses.

7. The control apparatus according to claim 6, wherein the one or more processors operate to:
control the first light emitters and the second light emitters,
acquire a first light amount using reflected light from an object when the second light emitters of the plurality of illumination apparatuses perform preliminary light emission with the light amount ratio, and
control the second light emitters to perform main light emission with the first light amount.

8. The control apparatus according to claim 6, wherein the one or more processors operate to:
control the first light emitters and the second light emitters,
acquire a first light amount using reflected light from an object when the second light emitters of the plurality of illumination apparatuses perform preliminary light emission with the light amount ratio, and
set the light amounts of the first light emitters of the plurality of illumination apparatuses using the first light amount.

9. The control apparatus according to claim 6, wherein the one or more processors operate to:
control the first light emitters and the second light emitters,
acquire a first light amount set for the first light emitter of each of the plurality of illumination apparatuses from each of the plurality of illumination apparatuses, and
set a light amount ratio of the second light emitters of the plurality of illumination apparatuses using the first light amount.

10. The control apparatus according to claim 6, wherein the plurality of illumination apparatuses include at least one illumination apparatus belonging to a first group and at least one illumination apparatus belonging to a second group, and
wherein the light amount ratio is a light amount ratio between the first group and the second group.

11. The control apparatus according to claim 1, wherein the first light emitter is an LED unit, and
wherein the second light emitter is a flashlight emitter.

12. The control apparatus according to claim 1, wherein the control apparatus is included in a sender flash apparatus attachable to and detachable from an image pickup apparatus.

13. The control apparatus according to claim 1, wherein the control apparatus is included in an image pickup apparatus.

14. The control apparatus according to claim 1, wherein the plurality of illumination apparatuses are receiver flash apparatuses disposed apart from an image pickup apparatus and configured to perform wireless communication with the control apparatus.

15. An illumination system comprising:
the control apparatus according to claim 1; and
the plurality of illumination apparatuses.

16. A control method for controlling a plurality of illumination apparatuses each having a first light emitter and a second light emitter, the control method comprising:
communicating with each of the plurality of illumination apparatuses,
setting a light amount of the first light emitter of each of the plurality of illumination apparatuses, and
acquiring a first light amount ratio of reflected light from an object obtained by causing first light emitters of the plurality of illumination apparatuses to emit light with the light amounts.

17. A control method for controlling a plurality of illumination apparatuses each having a first light emitter and a second light emitter, the control method comprising:
communicating with each of the plurality of illumination apparatuses,
setting a light amount of the first light emitter of each of the plurality of illumination apparatuses, and
setting a light amount ratio of the second light emitters of the plurality of illumination apparatuses using the light amounts of the first light emitters of the plurality of illumination apparatuses.

18. A non-transitory computer-readable storage medium storing a program that causes a computer to execute the control method according to claim 16.

19. A non-transitory computer-readable storage medium storing a program that causes a computer to execute the control method according to claim 17.
